(19) United States
(12) Patent Application Publication
(10) Pub. No.: US 2005/0217710 A1
(43) Pub. Date: Oct. 6, 2005

(54) Rapid deployment vehicle wash platform

(76) Inventor: Pasi Kaipaninen, Ann Arbor, MI (US)

Correspondence Address: Brinks Hofer Gilson & Lione, P O Box 10395, Chicago, IL, 60610, US

(21) Appl. No.: 10/515,254

(22) PCT Filed: May 23, 2003
(86) PCT No.: PCT/US03/16471

§ 371 Date: Nov. 19, 2004

Related U.S. Application Data
(60) Provisional application No. 60/383,042, filed on May 24, 2002.

(51) Int. Cl. B08B 3/00

(52) U.S. Cl. 134/123

(57) ABSTRACT

A convertible wash platform (10) for motor vehicles (11). The wash platform (10) has a plurality of modules (22) adapted to be reconfigurable between a first configuration and a second configuration. In the first configuration, the plurality of modules (22) defines the wash platform (10). At least some of the modules include water collection portions. In the second configuration, the plurality of modules (22) integrally define a transportable unit, whereby the transportable unit can be transferred to a deployment site and can be readily reconfigured into the wash platform (10) of the first configuration for use at the deployment site.

### BACKGROUND OF THE INVENTION

For safety and other reasons, it is often desirable to wash a vehicle before it leaves a particular site or location. Such situations can arise from natural disasters, man-made disasters, military activities, and even terrorist attacks.

Asbestos, glass particles and caustic powder are among the many continuing dangers after the collapse of a building. The World Trade Center towers contained 5000 tons of asbestos for insulation, just in the structural steel. This asbestos was part of the dust clouds that rolled through lower Manhattan and settled surrounding the site.

To protect people outside the contaminated zones, persons and vehicles must be cleaned prior to leaving the area. Because of the thin fibers inherent to asbestos, this kind and other contaminated dust must be taken up wet. While individuals can be decontaminated in tent stations, that they must leave the contaminated site through, heavy vehicles such as fire trucks and transport vehicles require a thorough vehicle wash so they do not contaminate outside the hot zone.

Vehicle wash systems capable of washing large trucks are generally massive systems at fixed locations. Trucks drive through spray arches to reach all sides of the vehicle. Water and chemical cleaning solutions are pumped throughout the system and water is collected and recycled or disposed of.

Disasters, military activities and terrorist attacks can occur anywhere in the world and, as such, vehicles need to be washed of contaminants in many different locations with the equipment being provided to these locations quickly and by means of various modes of transportation.

The ability to ship a system over road, rail, ocean and air, along with the ability for it to be lifted by various means, are desirable requirements.

The transportation industry, as well as the Department of Defense, has an ongoing initiative to standardize shipping containers so they may be easily deployed using truck, train, ship or plane. The United States participates in ANSI/ISO under the sponsorship of the American National Standards Institute. ANSI/ISO Technical Committee 104 handles a variety of matters related to freight containers. The Department of Defense and many other organizations have adopted these standards for transport containers.

In view of the foregoing, there exists a need for a vehicle wash platform that can be easily transported and rapidly deployed.

### BRIEF SUMMARY OF THE INVENTION

The present invention is a portable vehicle wash platform, capable of washing large trucks, that can be broken down and reconfigured such that the reconfigured platform itself forms a standard ANSI/ISO “container” that can be lifted by standard container handling equipment and can be transported by standard modes of container transportation.

A vehicle wash system that can be broken down and reconfigured into a container size that complies with the standards for ANSI/ISO containers could be rapidly deployed to a disaster zone or other location to wash vehicles exiting the site and reduce the risk of contamination in the surrounding areas.

### BRIEF DESCRIPTION OF THE DRAWINGS

FIG. 1a is a perspective view of a fully deployed wash station in accordance with the present invention;

FIG. 2 is a side view of the wash station seen in FIG. 1;

FIG. 3a-3g illustrate the wash station, seen in FIG. 1, in successive configurations as it is being reconfigured into a shipping container or containerized platform;

FIG. 4 is a perspective view of a wash station according to a second embodiment of this invention; and

FIG. 5 is a table illustrating various standard methods for lifting containers and the “containerized” wash platform of this invention.

### DETAILED DESCRIPTION

The following description of the preferred embodiments are merely exemplary in nature, and is in no way intended to limit the scope of the invention or its application or uses.

In the preferred combination, a portable vehicle wash platform 10 capable of washing large vehicles 11 such as trucks, cars, tractor-trailers, gravel or debris handlers, fire-trucks, and military vehicles is provided. The wash platform 10 can be disassembled and reconfigured as a standard sized ANSI/ISO container or containerized platform 12. The container 12 includes well known fittings 14 on its corners which meet ISO standards and allow lifting of the container 12 onto various means of transportation by different lifting methods. Once the containerized platform 12 is at the deployment site, it may be readily reassembled into its wash platform 10 configuration. This reassembly can be performed by a variety of means including manually, with a crane or by an automatic mechanism, such as hydraulic means, built into the vehicle wash platform 10.

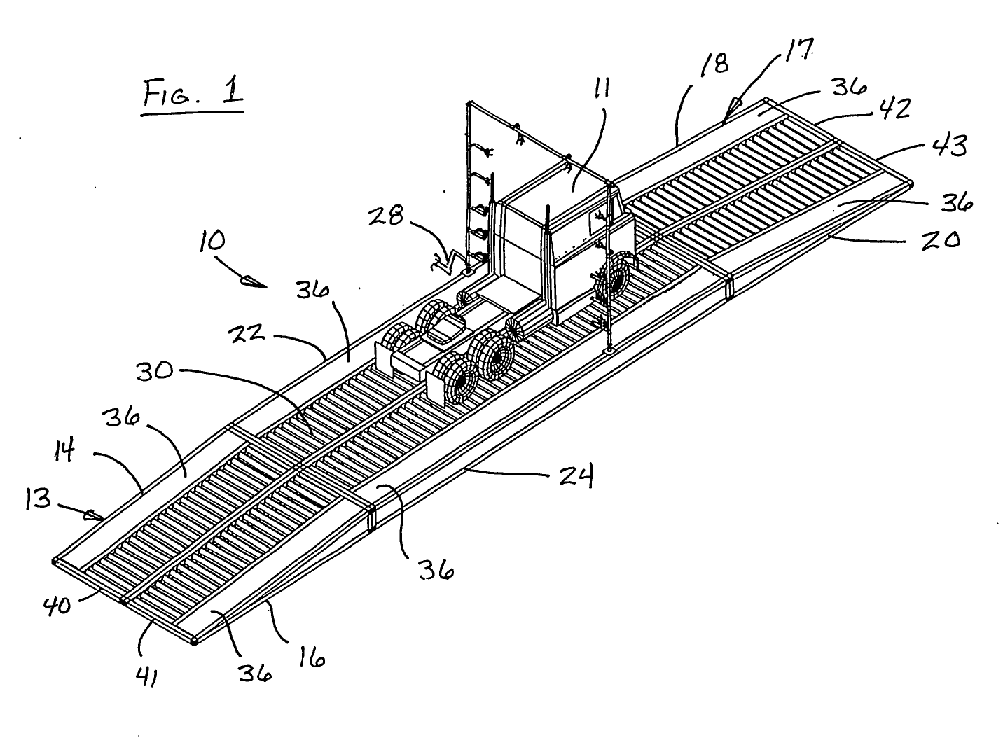

In one embodiment of the vehicle wash platform 10, six module portions are provided. These module portions includes an entrance ramp 13 with two entrance ramp modules 14, 16 for the vehicle 11 to drive onto the platform 10, an exit ramp 17 with two exit ramp modules 18, 20 for the vehicle 11 to drive off the platform 10 and two main platform modules for the vehicle to be supported upon while it is being washed. Several views of a vehicle wash platform 10 are shown in various stages of disassembly in FIGS. 1-3g.

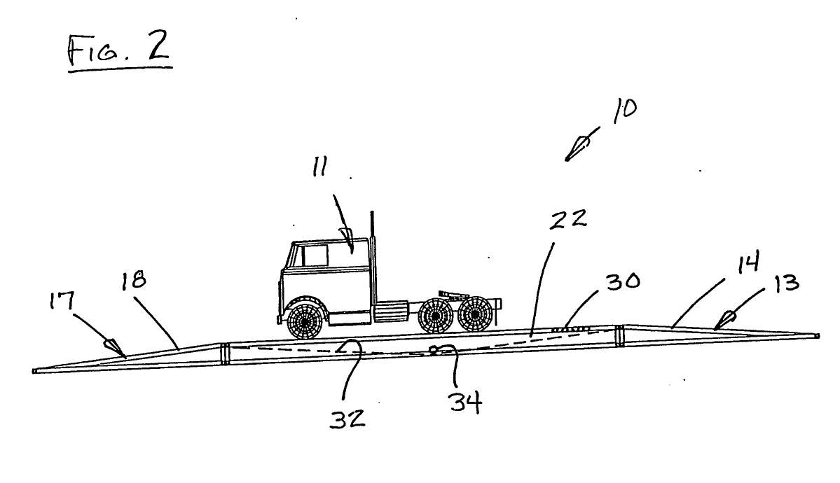

Referring to FIGS. 1 and 2, a spray arch 26 or multiple spray arches are attached to the main platform modules 22, 24 of the vehicle wash platform 10 to allow the vehicle 11 to pass therethrough and wash the truck 11 from a variety of angles. The arch 26 may otherwise be per a construction well known in the vehicle wash industry. Plumbing 28 is run through the vehicle wash platform 10 to bring water and/or chemicals to the spray arch 26, or the plumbing may connect directly to the arches. Various other mechanisms commonly necessary for vehicle washing can be self contained within the main modules and included in the system, as one skilled in the art will appreciate.

The main platform modules 22, 24 have a grate top surface 30 and built in sloped internal surfaces 32 to divert the dirty water from the vehicle wash to an outlet 34, which could lead to a settling pit constructed underneath the vehicle platform 10 or an integral pump (not shown) that sends the dirty water to another location for disposal and/or recycling. The entrance and exit ramps 13, 17 could also be provided with internal surfaces directing the water to collection areas after washing to be disposed of at a later time. The top portions of the various modules, for example in the areas of man-ways 36, are provided as removable panels for permitting access to the interior of the vehicle wash platform 10 and the various modules.

Provided according to this invention, the vehicle wash platform 10 can be brought to and removed from the contaminated site in its containerized condition 12, which has the external dimensions and capabilities of a standard ANSI/ISO shipping container. The overall or external dimensions of the containerized platform 12 is therefore 8 ft. (height)×8 ft. (width)×20 ft. (length) or 8 ft.×8 ft.×40 ft. Half heights and other divisions of the container dimensions may also be possible, so long as the end configuration of combined multiples is of a standard size.

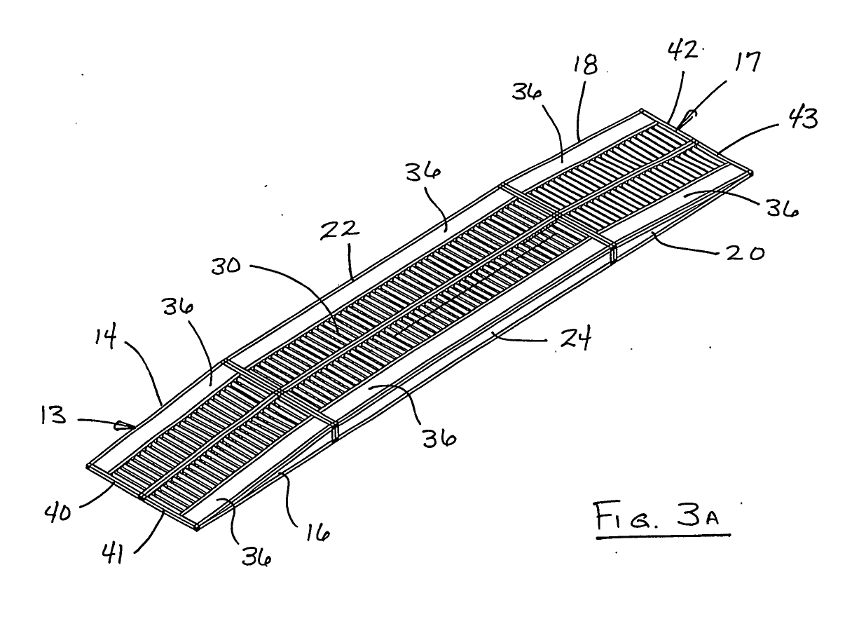

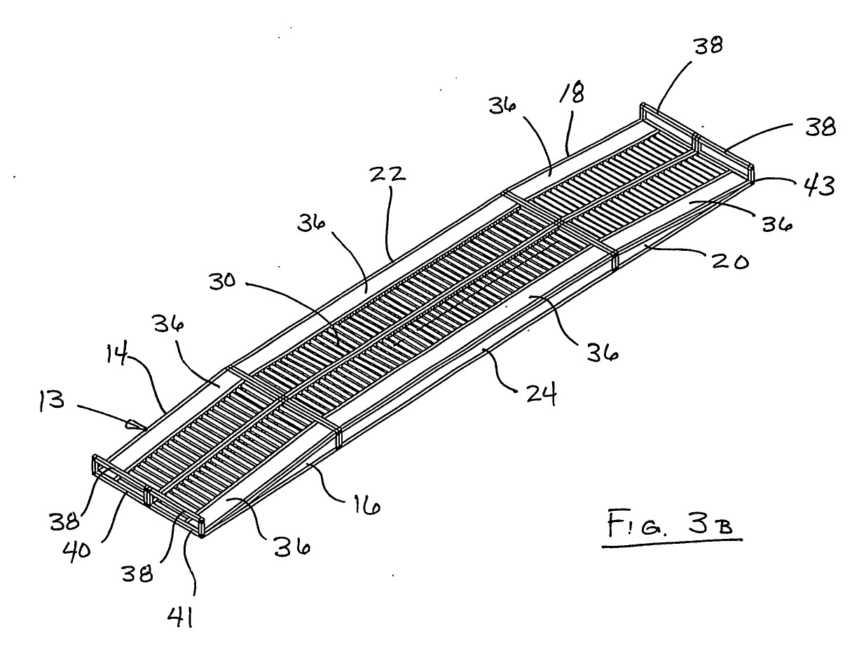

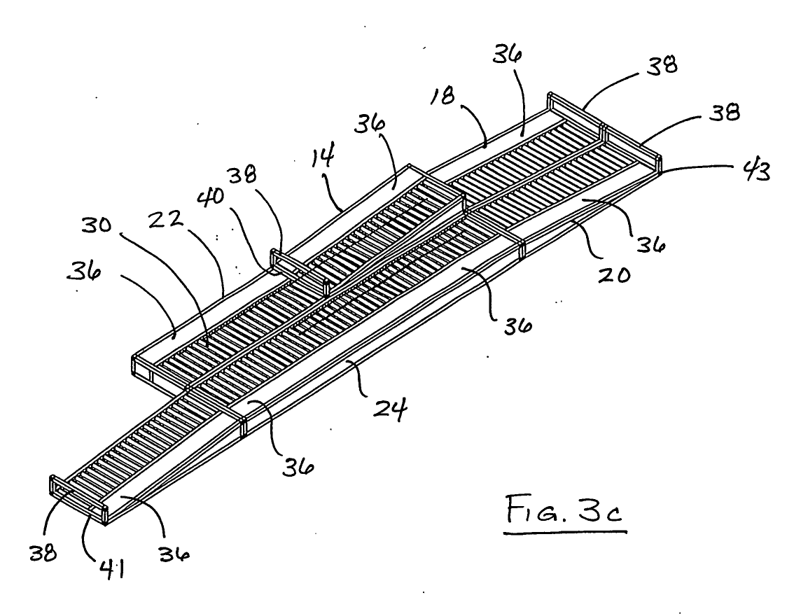

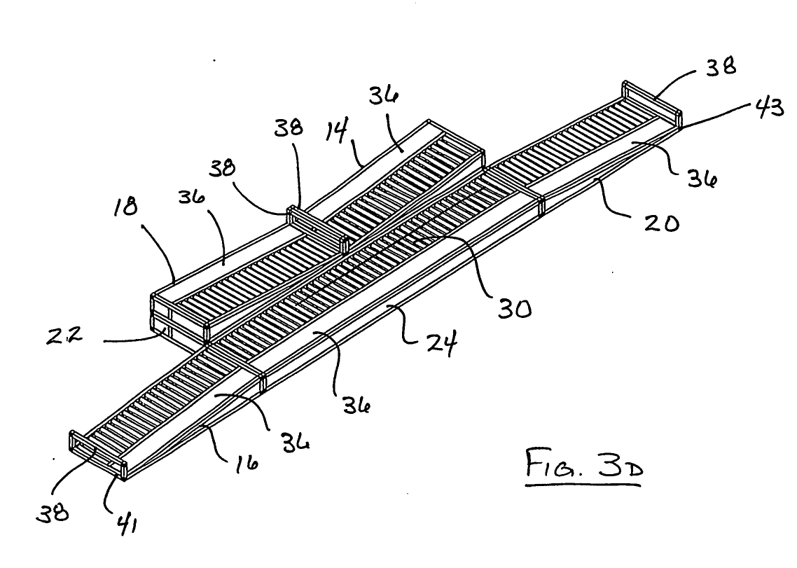

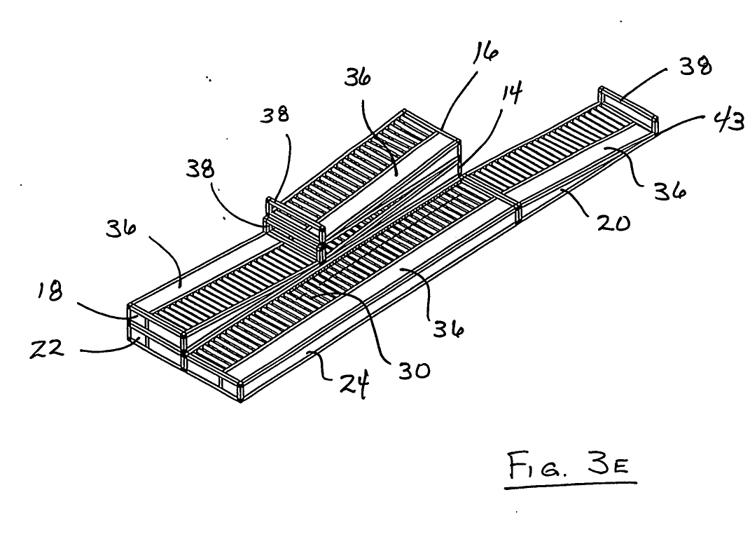

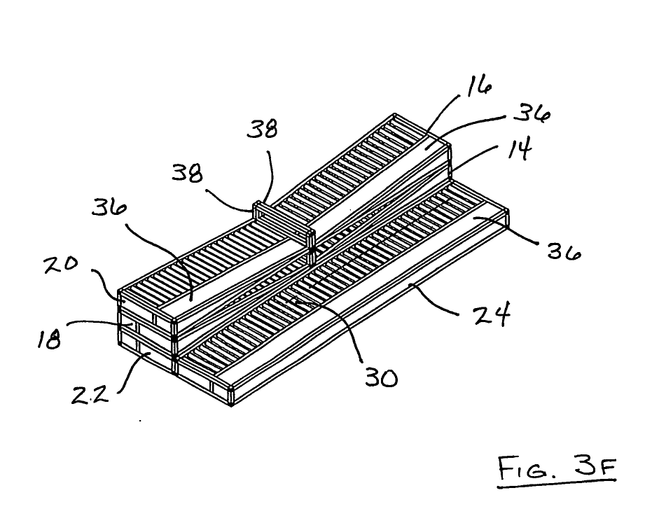

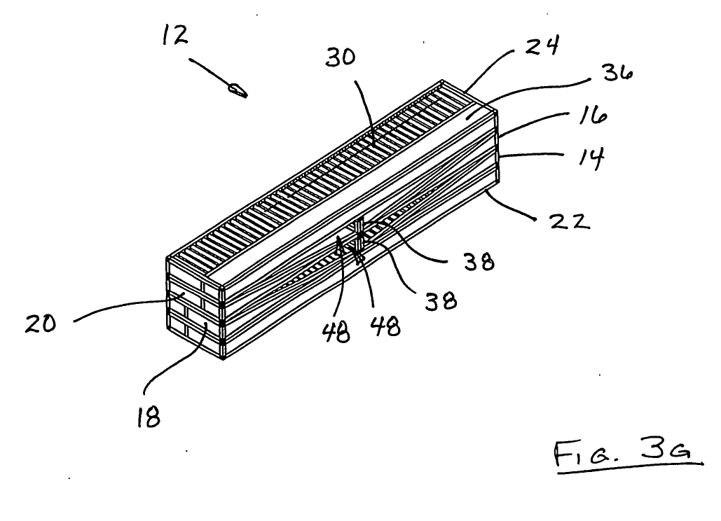

FIGS. 3a-3g illustrate one method by which the six individual modules of the vehicle wash platform 10 can be broken down and reconfigured during containerization. As will be apparent from the following discussion, converting the containerized platform 12 into the vehicle wash platform 10 entails the reversal of the steps mentioned below.

Starting from the vehicle wash platform 10 seen in FIG. 3a, end supports 38 are added to low height ends 40, 41, 42, 43 of the entrance and exit ramp modules 14, 16, 18, 20. The end supports 38 provide upright extensions to the low height ends 40, 41, 42, 43 and extend to a height corresponding with the height of the opposing ends of the entrance and exit modules 14, 16, 18, 20, about two feet in a full sized standard container version of the invention. The end supports 38 may be attached to the low height ends 40, 41, 42, 43 by various means, included having mounting tubes thereon inserted into recesses in the appropriate two corners of the modules 14, 16, 18, 20, fastening the end supports with pins, bolts, screws, interlocks or other such means.

The first entrance module 14 is then positioned on main platform module 22 such that its low height end 40 is centrally positioned on the main platform module 22, with its opposing end located toward the exit ramp module 18.

Exit ramp module 18 is similarly moved and positioned on the main platform module 22. Its low height end 41 and end support 38 are accordingly located adjacent to the low height end 40 and end support 38 of the first entrance ramp module 14. This is generally seen in FIG. 3d.

In similar fashion, the second entrance ramp module 16 and the second exit ramp module 20 are reconfigured and stacked on the first entrance ramp module 14 and the first exit ramp module 18, respectively. Illustrations of the above two steps are seen in FIGS. 3e and 3f.

Finally, the second main platform module 24 is positioned on top of the second entrance and exit ramp modules 16, 20. (See FIG. 3g). In this configuration, the vehicle wash platform 10 has been containerized and bears the dimensions of a standard sized shipping container.

The various modules 14, 16, 18, 20, 22, 26 are removeably secured with appropriate mechanisms to interlock or fit together when assembled. Such interlocks and mechanisms may include conventional fasteners, twist locks and other mechanisms, both during containerization and deployment.

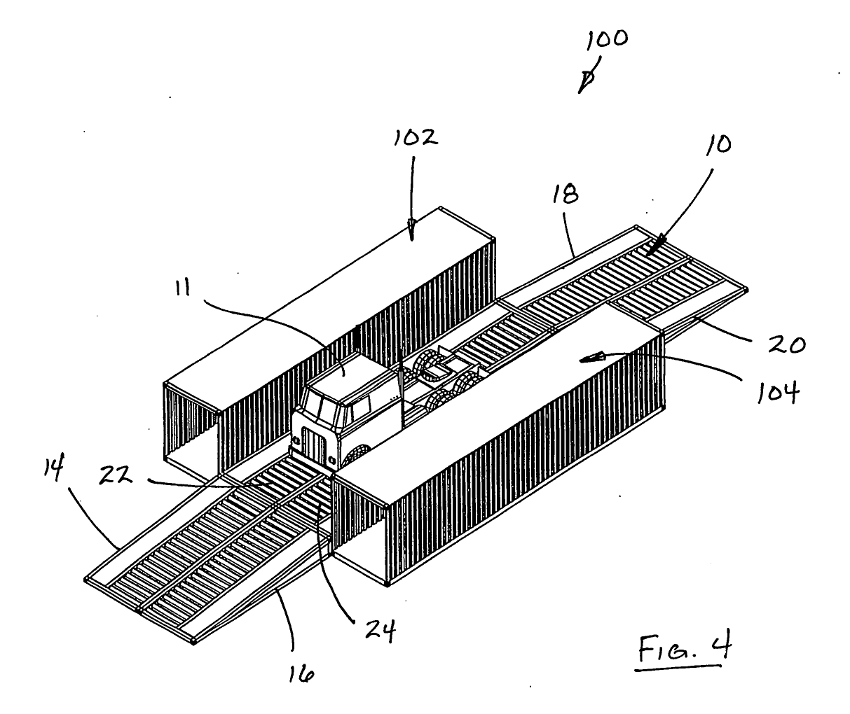

As mentioned above, standard ISO fittings are attached either after assembly or built-in to the modules so that the containerized platform 12 can be lifted by standard means and secured to the transport vehicle by standard securement methods. Examples of the lifting means and methods for the containerized platform 12 are shown in FIG. 4, and are provided such that the containerized platform 12 may be lifted by cranes, front-end lifts or other machinery. An example of such a securement mechanism includes twist-locks.

After containerization, the containerized platform 12 is seen to have recesses 48 or areas within it to store various wash system components such as pumps, spray arches, plumbing means, hoses, etc.

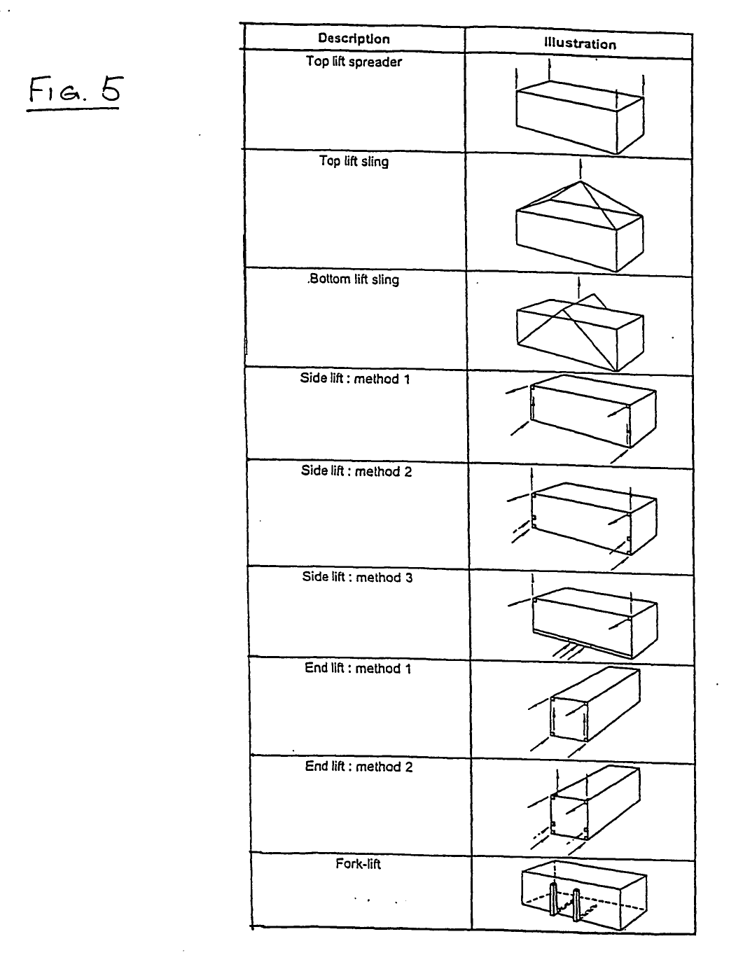

Because of the standard size and ability to be handled by standard means, as indicated in FIG. 5, and transported by standard means, the containerized platform 12 can easily be transported via truck, rail, ship or air. The containerized platform 12 also will exhibit a good distribution of weight, which will aide in vehicle stability during transportation. If desired, the recesses 48 can be left open in the sides of the containerized platform 12 to reduce the effects of wind during transport.

As can be readily understood by persons of ordinary skill in the art, the vehicle wash platform 10 may include and utilize other suitable devices and combinations. As seen in FIG. 4, a transportable and rapidly deployable wash system 100 could be provided utilizing more than one container. Such a system 100 includes the vehicle wash platform 10 described above, and also includes one or more other standard sized containers 102, 104. The containers 102, 104 are self-contained and include various other equipment required by the vehicle wash platform 10, including, without limitation, pumps, valve systems, control systems, water heaters, chemical tanks, water softeners, generators, filters, water tanks, reclamation tanks, etc. Connecting of the containers 102, 104 and their equipment, to the vehicle wash platform 10 is readily achieved by removing the man-ways 36 of one or both main wash modules 22, 24 and engaging the appropriate fittings and couplings appropriately provided between the containers 102, 104 and the main wash platforms 22, 24.

The foregoing discussion discloses and describes a preferred embodiment of the invention. One skilled in the art will readily recognize from such discussion, and from the accompanying drawings and claims, that changes and modifications can be made to the invention without departing from the true spirit and fair scope of the invention as defined in the following claims.

1. A convertible wash platform for motor vehicles, said wash platform comprising:
a plurality of interconnecting modules adapted to be reconfigurable between a first configuration and a second configuration, in said first configuration said plurality of modules defining said wash platform wherein at least some of said plurality of modules include water collection portions, in said second configuration said plurality of modules integrally defining a transportable unit whereby said transportable unit can be transported to a deployment site and can be readily reconfigured into said wash platform of said first configuration for use at the deployment site.

2. The wash platform of claim 1 wherein said transportable unit is in the shape of a shipping container.

3. The wash platform of claim 2 wherein said shipping container conforms to ANSI/ISO container specifications.

4. The wash platform of claim 1 wherein said transportable unit includes lift portions adapted to allow lifting of the transportable unit onto various means of transportation.

5. The wash platform of claim 1 wherein at least some of said plurality of modules include ramp portions to provide ingress and egress to and from said wash platform.

6. The wash platform of claim 1 further comprising a plurality of removable panels on at least some of said plurality of modules, said panels permitting access to inside of said wash platform.

7. The wash platform of claim 1 further comprising at least one spray arch assembly.

8. The wash platform of claim 1 further comprising plumbing means for directing water to said wash platform.

9. The wash platform of claim 1 wherein said plurality of modules includes at least three modules.

10. The wash platform of claim 1 wherein said plurality of modules includes six modules.

11. The wash platform of claim 10 wherein said six modules include two entrance ramp modules, two exit ramp modules and two main platform modules to be located between said entrance ramp modules and said exit ramp modules in said first configuration.
